(19) United States
(12) Patent Application Publication
(10) Pub. No.: US 2023/0417936 A1
(43) Pub. Date: Dec. 28, 2023

(54) POLYVINYL TOLUENE SCINTILLATORS PRODUCED USING CATIONIC PHOTOINITIATORS FOR ADDITIVELY MANUFACTURED RADIATION DETECTORS

(71) Applicants: Lawrence Livermore National Security, LLC, Livemore, CA (US); Colorado School of Mines, Golden, CO (US)

(72) Inventors: Jason Brodsky, Livermore, CA (US); Michael Joseph Ford, Livermore, CA (US); Alexandra Golobic, Pleasanton, CA (US); Connor Hook, Longmont, CO (US); Elaine Lee, Moraga, CA (US); Dominique Henry Porcincula, Oakland, CA (US); Xianyi Zhang, Newark, CA (US); Caleb Chandler, Golden, CO (US); Alan Sellinger, Golden, CO (US)

(21) Appl. No.: 18/086,379

(22) Filed: Dec. 21, 2022

Related U.S. Application Data
(60) Provisional application No. 63/294,042, filed on Dec. 27, 2021.

(51) Int. Cl. G01T 1/203; C08F 2/50; C08F 12/08; B33Y 70/00

(52) U.S. Cl. CPC G01T 1/2033; C08F 2/50; C08F 12/08; B33Y 70/00; B33Y 80/00

(57) ABSTRACT

A formulation for forming a styrene-based scintillator using light-directed additive manufacturing techniques includes a base monomer, a primary dye, a secondary dye, and a cationic photoinitiator. The base monomer includes one or more styrene-derivative monomers.

### RELATED APPLICATIONS

This application claims priority to Provisional U.S. Appl. No. 63/294,042 filed on Dec. 27, 2021, which is herein incorporated by reference.

This invention was made with Government support under Contract No. DE-AC52-07NA27344 awarded by the United States Department of Energy. The Government has certain rights in the invention.

### BACKGROUND

Plastic scintillator technology is used for detection, identification, and imaging of radiation sources through the ability of scintillators to produce light when interacting with ionizing radiation. While homogeneous monoliths produced by traditional bulk polymerization are most common, the fabrication and application of scintillator material formed by additive manufacturing, e.g., monoliths for rapid prototyping, pixilated arrays, more complex geometric structures, etc. is a developing area of advanced radiation detection. More complex structures enable advanced radiation detection capabilities such as determining particle identity, precisely localizing radiation interactions, and directional detection. However, fabricating such complex structures may rely on advanced techniques, such as additive manufacturing systems, e.g., three-dimensional (3D) printing. In addition to enabling complex architectures, advanced scintillator fabrication techniques can also provide alternative pathways for rapid fabrication of homogenous monoliths.

Plastic scintillators are composed of a polymeric matrix material for interacting with ionizing radiation; and the polymer matrix hosts dopants, e.g., fluorophores, that contribute to the conversion of the radiation's energy into detectable light. In general, new techniques, e.g., 3D printing, have been employed to fabricate scintillator material having an aromatic polymer matrix for efficient energy transfer of the excited states created by the ionizing radiation. Monomers that form aromatic polymers may include styrene derivatives, such as vinyl toluene. Even among aromatic polymers, there is variation in desirable performance parameters, including light output.

Polyvinyl toluene (PVT) is well known as a polymer matrix for plastic scintillators with excellent properties for radiation detection, including high light output and, in some cases pulse-shape discrimination (PSD) capability. PSD capability enables the detection of fast neutrons and gammas, and detection of thermal neutrons is possible with the addition of a neutron capture agent. One iteration of a PVT scintillator is valued for its high light output relative to other available plastic scintillators and has the benefit of increasing the precision of radiation detection measurement, and possibly PSD capability.

The conventional manufacture of PVT uses a thermal cure process that typically involves greater than 4 days and, in some instances, extends to weeks for complete curing. The long duration of the thermal curing process may be adequate for fabrication of bulk scintillators but remains a disadvantage that raises the cost of production time. In addition, the long duration of curing is prohibitive for additive manufacturing processes.

Additive manufacturing (e.g., 3D-printing) of PVT is desirable for a number of reasons. Light-directed additive manufacturing (AM) of scintillators confers many advantages to traditional thermal curing processes, including precise geometric control of fabricated part geometry and fabrication speeds closer to the span of several hours compared to several days. Thus, adapting light-directed additive manufacturing for producing PVT scintillators would allow 3D printing of complex geometric structures with fine features. For example, the Architected Multimaterial Scintillator System (AMSS, also known as multi-material scintillator system (MMSS)) would benefit from a fabrication of AM PVT on a microscopic scale formed in an efficient time frame. In the AMSS approach, a radiation detector uses a combination of multiple scintillator materials arranged according to one of several specially designed architectures to enable advanced radiation detection capabilities. As these architectures must be manufactured precisely, often down to the microscopic scale, AM is the most promising manufacturing technique available to produce these detectors. AM is also promising for more efficient production of pixelated scintillator array assemblies, which may be fabricated without multi-material fabrication. Moreover, innovations in AM hardware permits rapid printing of multiple formulations with different compositions (e.g., with a mixing nozzle) on a single platform.

Research into light-directed 3D printing of plastic scintillators has included non-styrene derivative monomers, using excessive amount of initiator, and/or using crosslinkers. Initial reports included 3D printed scintillators using a low phenyl content acrylate matrix with large amounts of 1-methylnaphthalene to provide aromatic content; however, this approach resulted in low light output, and also raises concerns regarding mechanical robustness and performance lifetime due to volatility of 1-methylnaphthalene. Other research in PVT-based scintillators has also shown the inclusion of non-phenylated acrylate crosslinkers and non-phenylated thiol crosslinkers can also decrease light output to similar lower levels. Other research with PVT-based matrices with phenylated acrylate monomers show improvements in light output compared to non-phenylated crosslinkers, but still show overall decreased light output. It is now generally known that an acrylate matrix is less effective in promoting scintillation. Furthermore, PVT-based matrices with notable amounts of crosslinkers (phenylated or not) may also decrease light output. A matrix material including high aromatic content is essential for promoting high light output. Higher amounts of aromatic content, e.g., naphthalene, may provide improved scintillation performance; however, the volatility and diffusion of a naphthalene-based component poses the risk of degrading light output over time.

Conventional polymerization of PVT uses a number of different thermal initiators that operate under a free radical polymerization process. Plastic scintillators exhibiting competitive performance to commercial standards have been fabricated using radical polymerization that is photoinitiated by visible light and cures in less than one day thereby demonstrating an improved curing time compared to using thermally initiated polymerization. However, the slow kinetics of radical mechanisms for the polymerization of styrene derivatives still present difficult challenges for adapting light-directed additive manufacturing methods. A significant drawback of a free radical polymerization process is that the photoinitiators result in a polymerization time duration of minutes to hours. For example, photopolymerization of styrene using common free radical photoinitiators such as bis(2,4,6-trimethylbenzoyl)phenylphosphine oxide (BAPO) results in only 50% vinyl group conversion after tens of hours. The slow polymerization process creates significant challenges to fabricate AM plastics that are cured by photopolymerization. Unfortunately, a slow polymerization process results in slow prints, difficulty printing large quantities of material, imprecise control of the printed structure, etc. Additive manufacturing processes that employ light-directed 3D printing need kinetics of photopolymerization in a time frame compatible with additive manufacturing techniques, for example, in a range of seconds to minutes, in order to efficiently print a complex structured plastic PVT scintillator.

Adjusting an amount of each key component and/or including additive to promote free radical polymerization does not solve the problem of slow kinetics to form an efficient scintillator product. In one instance, photopolymerization of a vinyl toluene-based scintillator using free radical polymerization included large amounts of photoinitiator (e.g., about 5 wt. %) and binders (10 wt. %), however, the light yield of these plastic scintillators was reported to be only 70% relative to a commercially available PVT-based monolith plastic scintillator (EJ-200). Thus, another drawback of forming a polymer matrix using free radical polymerization is the need for additional components (e.g., binders, crosslinkers, etc.) to the composition that in turn results in subsequent lower light yields. Thus, the solution of how to solve the problem of quickly photocuring a styrene-based plastic scintillator matrix material without significantly altering the composition remains elusive.

### SUMMARY

In one inventive aspect, a formulation for forming a styrene-based scintillator using light-directed additive manufacturing techniques includes a base monomer, a primary dye, a secondary dye, and a cationic photoinitiator. The base monomer includes one or more styrene-derivative monomers.

In another inventive aspect, a product includes a printed three-dimensional structure comprising a scintillator material including a styrene-derivative-based polymer matrix, a primary dye, and a secondary dye. The printed three-dimensional structure has a plurality of layers arranged in a geometric pattern.

In yet another inventive aspect, a method for forming a scintillator product includes obtaining a formulation including a base monomer having one or more styrene-derivative monomers, a primary dye, a secondary dye, and a cationic photoinitiator. The formulation is exposed to light for polymerizing the formulation to form a structure having a styrene-derivative-based polymer matrix. The structure is heated to cure the polymer matrix to at least a predefined extent.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIGS. 1A-1B depict schematic drawings of a cationic mechanism of polymerization reaction, according to one inventive aspect. Part (a) depicts the photogeneration of initiator, part (b) depicts the propagation of polyvinyl toluene, and parts (c), (d), and (e) depict various termination mechanisms of the polymerization reaction.

FIG. 2 is a flowchart of a method for forming a PVT scintillator using cationic photopolymerization, according to one inventive aspect.

FIG. 3 depicts the spectral overlap of absorbers and emitters in a formulation, according to one inventive aspect.

FIG. 4A is an image of bulk scintillator samples formed by various formulations, according to one inventive aspect.

FIG. 4B is an image of 3D printed scintillator samples using a formulation including a cationic initiator, according to one inventive aspect.

FIG. 5 is a comparison of exotherms, measured using a PhotoDSC device, of formulations having different amounts of primary fluorophore, according to one inventive aspect.

FIG. 6 depicts a series of plots showing curing as a function of light intensity using PhotoDSC analysis, according to one inventive aspect. Part (a) depicts an exotherm curve of undoped vinyl toluene with photoinitiator, part (b) is a plot of peak area correlating to increasing light intensity, part (c) is a plot of peak position correlating to increasing light intensity, and part (d) is a plot of the peak height correlating to increasing light intensity.

### DETAILED DESCRIPTION

The following description is made for the purpose of illustrating the general principles of the present invention and is not meant to limit the inventive aspects claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

As used herein, the term “essentially” denotes an interval of accuracy that ensures a meaning of “mostly” but may not be exclusively 100%. The term “essentially” may denote 99.0% to 99.9%.

It is also noted that, as used in the specification and the appended claims, wt. % is defined as the percentage of weight of a particular component relative to the total weight/mass of the formulation. Vol. % is defined as the percentage of volume of a particular compound relative to the total volume of the formulation or compound. Mol. % is defined as the percentage of moles of a particular component relative to the total moles of the formulation or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

In addition, the present disclosure includes several descriptions of a “resin” used in an additive manufacturing process to form the inventive aspects described herein. It should be understood that “resins” (and singular forms thereof) may be used interchangeably and refer to a composition of matter comprising a plurality of particles, small molecules, etc. coated with and dispersed throughout a liquid phase. In some inventive approaches, the resin may be optically transparent having a greater than 90% transmittance of light. In some inventive approaches, the resin is light sensitive where exposure to a particular light source changes the physical and/or chemical properties of the resin.

The following description discloses several preferred structures formed via photo polymerization processes, e.g., projection micro-stereolithography, photolithography, two photon polymerization, etc., or other equivalent techniques and therefore exhibit unique structural and compositional characteristics conveyed via the precise control allowed by such techniques. The physical characteristics of a structure formed by photo polymerization processes may include fabrication of a solid micro-structure having complex geometric arrangement of ligaments, filaments, etc. The three-dimensional structure formed from a resin exposed to light, wherein a pattern in the photoresist is created by the exposing light.

The following description discloses several preferred inventive aspects of polyvinyl toluene scintillators produced using cationic photoinitiators for additively manufactured radiation detectors and/or related systems and methods.

In one general inventive aspect, a formulation for forming a styrene-based scintillator using light-directed additive manufacturing techniques includes a base monomer, a primary dye, a secondary dye, and a cationic photoinitiator. The base monomer includes one or more styrene-derivative monomers.

In another general inventive aspect, a product includes a printed three-dimensional structure comprising a scintillator material including a styrene-derivative-based polymer matrix, a primary dye, and a secondary dye. The printed three-dimensional structure has a plurality of layers arranged in a geometric pattern.

In yet another general inventive aspect, a method for forming a scintillator product includes obtaining a formulation including a base monomer having one or more styrene-derivative monomers, a primary dye, a secondary dye, and a cationic photoinitiator. The formulation is exposed to light for polymerizing the formulation to form a structure having a styrene-derivative-based polymer matrix. The structure is heated to cure the polymer matrix to at least a predefined extent.

A list of acronyms used in the description is provided below.
3D three-dimensional
3HF 3-hydroxyflavone
AM additive manufacturing
AMSS Architected multimaterial scintillator system
DLP Digital light processing
FoM figure of merit
cm centimeter
MeV mega electronvolts
MMSS Mixed-material scintillator system
ms millisecond
nm nanometer
PhF 9,9-dimethyl-2-phenylfluorene
PhotoDSC photo differential scanning calorimetry
POPOP 1,4-bis(5-phenyloxazol-2-yl) benzene
PPO 2,5-diphenyloxazole
PSD pulse shape discrimination
PVT polyvinyl toluene
μm micron
mW milliwatt
SFS 9,9-dimethyl-2,7-di((E)-styryl) fluorene
SLA Stereolithography
UV ultraviolet
VT vinyl toluene
wt. % weight percent

According to one inventive aspect, a PVT scintillator is produced using a vinyl toluene (VT) monomer solution, a cationic photoinitiator, and one or more scintillator dyes. When the composition is exposed to light, the cationic photoinitiator causes rapid polymerization of the components of the formulation that are compatible with building techniques of three-dimensional (3D) printing, e.g., layer-by-layer building, volumetric printing, etc. For example, during 3D printing, as each layer of resin is exposed to light, e.g., in a burst of light, the resin layer polymerizes to solid, then a subsequent layer of resin is gathered at the print plane, the resin layer is exposed to light and polymerized to a solid, etc. Moreover, the light source in the AM technique allows a print image to be changed between layers of a single build. Cationic photo-polymerization allows for the rapid curing of a vinyl toluene (VT) and fluorophore solution into a solid scintillating material. Moreover, a solid material converted from a liquid formulation may be obtained at higher conversion rates under a wide range of cationic initiator concentrations without the addition of crosslinkers.

Inventive aspects described herein include an approach to photo polymerization that utilizes a cationic photoinitiator. It has been generally understood by those skilled in the art, that in the case of styrene-derivatives, water or alcohols behave as Lewis bases relative to the super acidic growing polymer chain. In so doing, very small amounts of a protic cation source, e.g., water, methanol, etc. might be used during initiation of polymerization as a proton source, but not as a solvent for the reaction. To the best of the inventors' knowledge, photocationic polymerization of polyvinyl toluene has only been known to occur in a solvent that allows the growing polymer chains to remain solubilized throughout the propagation of the polymer chain, and, further, high conversion rates have only been achieved using the most reactive photoiniators. In this inventive aspect, vinyl toluene is the solvent, which converts to PVT polymer upon reaction until the resin reaches a point of solidification, locking in polymer chains and drastically changing the environment of polymer propagation.

Moreover, formulations for PVT scintillator material typically do not include a solvent because a solvent would introduce opportunities for voids to form in the solid material. Thus, it has been generally understood that a cationic polymerization process that typically relies on a solvent for efficient and complete polymerization was not a preferable method for forming a solid optically transparent scintillator material. However, as described herein, cationic polymerization offers significant advantages that overcome the drawbacks of free radical polymerization.

Moreover, cationic photopolymerization is less known in use with styrene derivatives. The cationic photoinitiators are not designed for styrene derivatives, and rather cationic initiators for rapid photopolymerization are designed for cyclic ethers, e.g., epoxides, furans, oxetanes, etc. Although styrene derivatives as a co-polymer with acrylate monomers have been shown to undergo photopolymerization, it was unclear whether a composition comprising purely styrene derivatives would be capable of cationic photopolymerization where the polymerization reaches sufficiently and practically high conversion, e.g., the polymerization goes to completion. If conversion is greater than 80% of the original concentration of monomers, then the polymerization reaction may be considered to have reached sufficient conversion.

Furthermore, cationic polymerization tends to be sensitive to the presence of moisture, etc. such that water can quench the reaction by reacting with the propagating carbocation. In some instances, moisture, or other electron donors, will typically inhibit a cationic polymerization reaction. In addition, typical cationic polymerization reactions have extremely fast kinetics, and, thus, cationic inhibitors may be considered to optimize light-directed 3D printing techniques.

Vinyl toluene may undergo cationic, anionic, radical, etc. polymerization mechanisms. According to one inventive aspect, diaryliodonium salt photoinitiators may be included in a formulation with vinyl toluene to fabricate polyvinyl toluene scintillators from liquid vinyl toluene via a cationic mechanism.

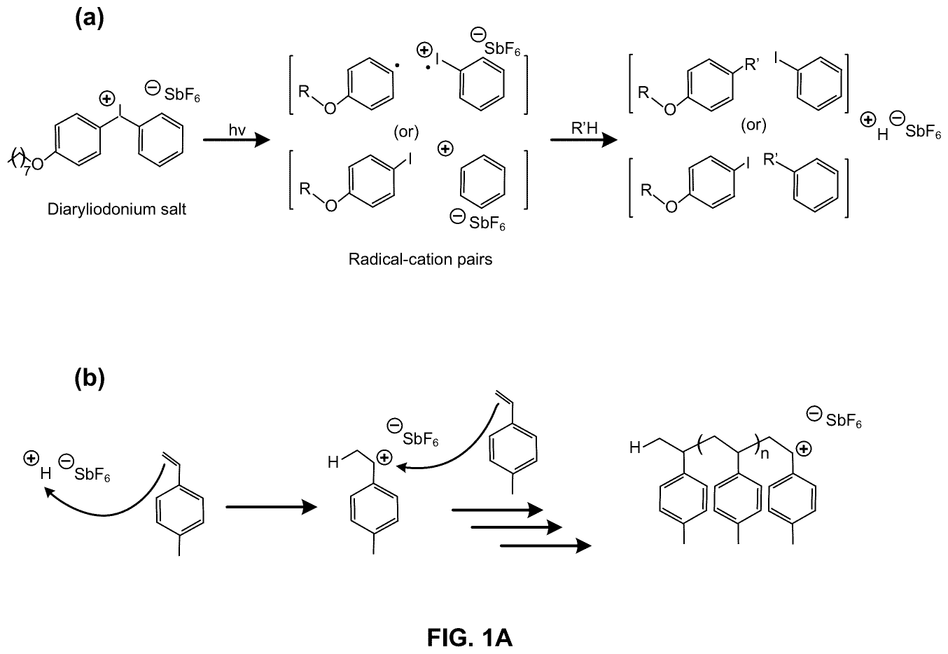

FIG. 1A depicts a mechanism of cationic polymerization of vinyl toluene. An initial step of the cationic polymerization process includes photogeneration of the initiator as shown in the schematic drawing of part (a). In this case, the cationic initiator, a diaryliodonium salt being exposed to light hv undergoes photolysis to form reactive intermediates, such as radical-cation pairs. The various hydrocarbon components of the resin may act as a proton source (R¹H) for the reactive intermediates, resulting in the final formation of the super acid HSbF₆ that initiates cationic polymerization. In the formulation described herein, the proton source (R¹H) is generated from one of the components of the formulation. In other words, a specific component designated as a proton source is not added into the formulation.

Part (b) of FIG. 1A represents a propagation of polyvinyl toluene. The growing chain of vinyl toluene monomers is the active species having a cationic end group, e.g., a benzyl carbenium cation, generated from the most recently added monomer that in turn allows addition of the nucleophilic alkene group of the next vinyl toluene monomer.

Parts (c), (d), and (e) of FIG. 1B represents various termination mechanisms of the growing chain of vinyl toluene monomers that signals the completion of polymerization. For example, essentially all of the free vinyl toluene molecules are polymerized into polyvinyl toluene chains. Termination may occur when a growing chain end reacts with a non-monomeric electron donor, such as water, that eliminates the propagating carbocation yielding a non-reactive chain end. In the absence of nucleophilic available groups to donate electrons to the cationic end group of the polyvinyl toluene chain, a carbon atom of an adjacent phenyl group, where the carbon atom has a partial negative charge, may attack the cationic site, and form a bond thereby stabilizing the polymer. As illustrated in parts (c), (d), and (e), the chain end may also undergo beta-hydrogen elimination to form a terminal alkene and HSbF₆.

In one inventive aspect, a formulation for forming a styrene-based scintillator using light-directed additive manufacturing techniques includes a base monomer having one or more styrene derivative monomers, a primary dye, a secondary dye, and a cationic photoinitiator. Preferably the base monomer includes at least one or more of the following: a vinyl toluene (VT) monomer, a styrene monomer, a divinylbenzene monomer, a methyl-substituted styrene derivative, etc. In some approaches, styrene derivatives having electron donating groups substituted on the aromatic ring of the styrene monomer may increase reactivity in a cationic system. In some approaches, the base monomer may include a multifunctional monomer. The multifunctional monomer may have at least two functional sites for crosslinking. In one approach, a styrene monomer, such as divinylbenzene, may also contribute as a crosslinker because each divinylbenzene molecule has two functional sites for crosslinking. In some approaches, the base monomer may include a combination of different types of monomers.

Vinyl toluene monomers may be obtained commercially, and preferably have any manufacture-added inhibitor removed from the vinyl toluene before mixing the formulation. In some approaches, the formulation does not include any other monomer than the base monomer, the base monomer being one or more styrene-derivative monomers. For example, in one approach, the formulation may include a composition of vinyl toluene monomers. In one approach, the formulation does not include a co-polymer, such as acrylate monomer.

In other approaches, the formulation includes a combination of monomers, such as a combination of vinyl toluene and a co-polymer. In one approach, the formulation includes an acrylate monomer.

According to one inventive aspect, the one or more styrene-derivative monomers may effectively act as a solvent for dissolution of the primary and secondary dyes of the formulation. In one approach, the vinyl toluene component is the solvent of the formulation. The formulation does not include an additional solvent, and thus, the formulation does not include typical protic additions such as water, methanol, etc. Preferably, the formulation is essentially free of a protic solvent such as water, methanol, etc. As described herein, the proton/cation participating in the photoinitiation step is a component of the formulation of the resin. Without wishing to be bound by any theory, it is believed that the proton/cation initiator in the formulation is most likely generated by the violent breaking of a C—H bond rather than the presence of water, alcohols, which are not components of the formulation.

A formulation of the resin for cationic polymerization includes small molecules that are soluble in one or more styrene-derivative monomers. For example, the formulation may include oligomers, monomers, polymers, etc. that are soluble in a liquid. The resin preferably is essentially free of solid particles such as silica, binders, etc. In one approach, the resin may be a liquid suspension without colloidal-type suspensions, dispersions, etc. In some approaches, the resin may include particles such as silica, quantum dots, binder, etc.

In preferred inventive aspects, hydrocarbon fluorophores are included in a VT composition for forming a PVT scintillating material by cationic polymerization. Hydrocarbon fluorophores allow complete curing of the PVT material by cationic polymerization. The primary and secondary dopants, e.g., dyes, are comprised of primarily carbon and hydrogen. In preferred approaches, the primary dye is an aromatic hydrocarbon fluorophore and the secondary dye is an aromatic hydrocarbon fluorophore, and the primary dye and the secondary dye are different. In one approach, hydrocarbon fluorophores may be prepared using Suzuki coupling or Heck reaction. In various approaches, a Suzuki coupling, Heck reaction, and/or other relevant reactions may be used to produce primary and secondary fluorophores of interest.

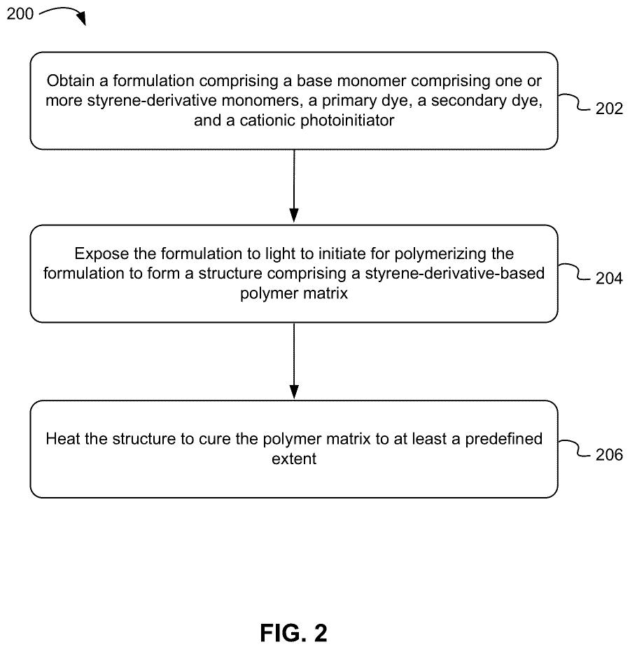

In various approaches, the dyes may include terphenyl derivatives, fluorene derivatives, polycyclic aromatic compounds, etc. For example, the primary dye may include 9,9-dimethyl-2-phenylfluorene (PhF). The secondary dye may include 9,9-dimethyl-2,7-di((E)-styryl)fluorene (SFS), a 3-hydroxyflavone (3HF) dye, m-Terphenyl (Millipore Sigma, St. Louis MO), biphenyl (Millipore Sigma, St. Louis MO), 1,4-Bis(2-methylstyryl)benzene (Bis-MSB, Millipore Sigma, St. Louis MO), 9,10-Diphenylanthracene (Millipore Sigma, St. Louis MO), etc. Secondary dyes are preferably present to prevent self-absorption. The secondary dye SFS has more rings and linkages than the primary dyes PhF (as shown in the illustration of SFS and PhF in FIG. 3). As generally understood in the field, the scintillator dyes may be replaced by alternative dyes with similar properties.

In an exemplary approach, secondary dyes have a significant effect on penetration depth, an essential parameter to control in light directed AM. In some approaches, a secondary fluorophore, and in some cases a primary fluorophore, may act as a photoinhibitor, photoblocker, etc. depending on the wavelength of light being used in light directed AM. Photo blockers are often added to light directed AM to limit the penetration depth of light and increase print resolution; however, fluorophores in scintillator formulations may function as photo blockers such that additional photo blockers are not needed to be included in the formulation for light-directed AM. Dopants may be selected for both their ability to promote scintillation and for their impact on print processes.

In PVT scintillator systems, PhF as the primary dopant in plastic scintillators has been shown in some cases to outperform 2,5-diphenyloxazole (PPO), a commonly used primary dopant in organic scintillators. This dopant is not compatible with the cationic polymerization process, as discussed below, however it was shown that purely hydrocarbon dopants such as PhF and SFS are high-performing fluorophores in PVT scintillator material formed by cationic polymerization. In other approaches, a hydrocarbon fluorophore class having at least two phenyl groups, such as Exalites (BOC Sciences, Shirley, NY), might perform well as a dopant in the formulation. In one approach, the primary dye is a first aromatic hydrocarbon and/or the secondary dye is a second aromatic hydrocarbon.

Although it is common for traditional scintillator material to include primary and/or secondary dopants that include nitrogen atoms, cationic polymerization reactions are incompatible with nitrogen atoms that function as a Lewis base, such that the presence of nitrogen atoms in alkyl amines, heterocycles, etc. in a cationic polymerization process will terminate the reaction. In preferred formulations, the primary and secondary dyes do not include nitrogen, and in some cases do not include oxygen, since dyes that have a nitrogen and oxygen tend to prevent curing via the cationic polymerization mechanism. Well known scintillating fluorophores having oxazole functional groups, such as 2,5-diphenyloxazole (PPO) and 1,4-bis(5-phenyloxazol-2-yl) benzene (POPOP) are not preferred choices for fluorophores for PVT scintillator material cured by cationic photopolymerization. In particular, scintillating fluorophores having oxazole functional groups tend to quench cationic polymerization.

The cationic initiator is preferably a super acid. In preferred approaches, the cationic initiator is an iodonium salt that forms a super acid in situ. Exposure of the cationic initiator to a light causes the formation of the ion species having a reactive anion that in turn initiates a plurality of reactions resulting in super acid formation. The rate of cationic polymerization may vary with the anion formed by the cationic initiator, e.g., the initiating salt species, during the cationic polymerization process. The cationic initiator forms an ionic species, e.g., H⁺SbF₆⁻ as in the case of HNu-254, and the anion hexafluorostibate SbF₆⁻ will coordinate quickly and efficiently with positively charged species in the vicinity of the reaction. The bulky structure of the anion hexafluorostibate SbF₆⁻ encourages the reaction to happen quickly. In some approaches, non-iodonium salts that have a bulky anion, e.g., hexafluorostibate, may be able to initiate cationic polymerization in a similar manner as an iodonium salt having the bulky anion hexafluorostibate. In some contemplated approaches, photoinitiators comprised of phosphorous- and sulfurous-based anions did not demonstrate any polymerization activity, compared with robust polymerization in the presence of hexafluorostibate.

In one inventive aspect, the cationic photoinitiator includes an iodonium salt. In a preferred approach, the cationic photoinitiator includes an iodonium hexafluorostibate salt. In general, any photocationic initiator that results in a large anion, e.g., antimony hexafluoride may be advantageous. These compounds may be chemically modified to allow initiation at different wavelengths in the UV or visible range. In one approach, an exemplary cationic initiator may be HNu-254, 99% 4-(octyloxy)phenyl)(phenyl)iodonium hexafluorostibate(V) in combination with 1% diphenyliodonium 9, 10-dimethyoxyanthracene-2-sulfonate.

Table 1 includes the range of amount of each component of a preferred formulation for forming a PVT scintillator, according to one inventive aspect. In one example of the formulation, the vinyl toluene (VT) monomer may be combined with about 2 wt. % PhF (primary dye), about 0.1 wt. % SFS (secondary dye), and about 0.03 wt. % H-Nu 254. The formulation does not include an additional solvent, the liquid vinyl toluene is the solvent that dissolves the solid components, e.g., the dyes and photoinitiator The formulation is cationically photopolymerized from a liquid to a solid without an additional solvent.

In some approaches, the formulation may include an additive. In one approach, an additive may be included to adjust the curing of the formulation used for cationic polymerization. In various approaches, the additive may be included to mitigate color of the cured product, modify the curing light, modify the cationic polymerization

TABLE 1
Components of a Formulation for Cationic Photopolymerization
to form a PVT scintillator

| Component | Example 1 | Amount (wt. %) of total formulation |
|---|---|---|
| Base monomer | Vinyl Toluene | up to 100 wt. % |
| Primary dye | PhF | about 1 to about 40 wt. % |
| Secondary dye | SFS | greater than 0 to about 0.5 wt. % |
| Cationic Initiator | H-Nu 254 | about 0.01 to about 0.5 wt. % |

reaction, etc. For example, the additive may include one of the following for mitigating color in the cured product: benzophenone, sodium sulfite, sodium thiosulfate, etc.

In other approaches, an additive may be included that is typically included for fabricating hard plastic scintillators. For example, additives may include crosslinkers, thermal neutron absorbers, etc. With some photoactive resins used in light-directed 3D printing, polymerization may propagate outside the intended projection area, thereby decreasing part resolution as well as potentially creating inhomogeneities in the resin bath (and subsequently the printed part) as resin becomes partially polymerized. This may be prevented by including various additives in the resin formulation. In some approaches, the additive may include various types of photoinhibitors. In one approach, one type of photoinhibitor, e.g., a UV blocker, absorbs stray photons and limits spread and penetration depth of light into resin, thereby minimizing photoinitiation outside of the intended projection area. In one approach, as demonstrated in radical acrylate systems, a secondary dopant may function as a photo blocker in cationic polymerization systems. In another approach, another type of photoinhibitor causes chemical quenching, where compounds actively quench or terminate polymerization reactions.

In some approaches, a method for enhancing part resolution may include the addition of crosslinkers. Solidification in photoinitiated VT occurs through the conversion of VT monomers into PVT chains; and at sufficient conversion, PVT chains will entangle and subsequently form a thermoplastic solid. However, while the initiation of the polymerization process is light-based, the conversion of VT monomers to PVT chains is a diffusion-dominated process, and therefore spatial control of the polymerization reaction is limited. The addition of crosslinkers, such as divinylbenzene (DVB), allows for the formation of a crosslinked, thermoset polymer network, where solidification is driven through the formation of a polymer network rather than solely relying on polymer chain entanglement. In one approach of AM techniques where polymerized part is held submerged underneath a vat of resin, crosslinking may be advantageous for preventing the polymerized part from swelling with resin and also for keeping the polymerized part from dissolving into the vat during the printing process. The formation of a solid polymer network is generally a much faster process than forming a solid thermoplastic and allows for much greater spatial control and precise geometry.

Preferably, the amount of primary dye is in a range below 40 wt. % of the formulation. At higher concentrations of primary dye, the solubility limit of the dye may be surpassed thereby resulting in the formation of precipitates inside the transparent plastic, and a significant number of precipitates would result in a haze, opaqueness, etc. that prevents light from escaping the plastic scintillator material. Moreover, since the plastic scintillator material may become softer as the amount of dopant is increased, the dopant may function as a plasticizer. Preferably, the concentration of the dopant is sufficient that the plastic scintillator material is a hard plastic material that can be polished, machined, etc.

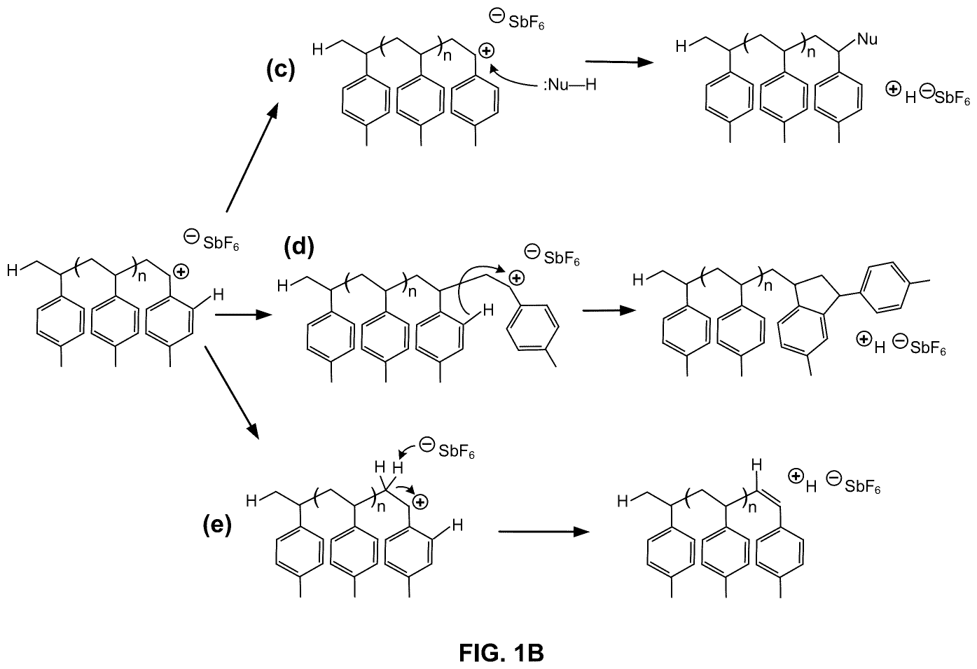

FIG. 2 shows a method 200 for forming a scintillator product using cationic polymerization, in accordance with one inventive aspect. As an option, the present method 200 may be implemented to construct structures such as those shown in the other FIGS. described herein. Of course, however, this method 200 and others presented herein may be used to form structures for a wide variety of devices and/or purposes which may or may not be related to the illustrative inventive aspects listed herein. Further, the methods presented herein may be carried out in any desired environment. Moreover, more, or less steps than those shown in FIG. 2 may be included in method 200, according to various inventive aspects. It should also be noted that any of the aforementioned features may be used in any of the inventive aspects described in accordance with the various methods.

Step 202 includes obtaining a formulation that includes a one or more styrene-derivative monomers, a primary dye, a secondary dye, and a cationic photoinitiator. In a preferred approach, the formulation includes vinyl toluene monomers. In some approaches, the formulation is formed by combining the solid components such as the cationic photoinitiator, primary and secondary dyes and then mixing in the liquid vinyl toluene monomer to 100%. The formulation may be formed in the dark to avoid exposure to ambient fluorescent light. Prior to addition of the vinyl toluene monomer to the formulation, the vinyl toluene monomer is stripped of its inhibitor. The formulation may be stored at −20° C. to prevent reactions. The formulation does not include a solvent.

Step 204 includes exposing the formulation to light for polymerizing the formulation to form a structure having a styrene-derivative-based polymer matrix. In one approach, the formulation is warmed to room temperature to initiate polymerization of the formulation. The duration of the curing depends on the size of the sample and the intensity of the light.

Step 206 includes heating the structure to cure the polymer matrix to at least a predefined extent. In preferred approaches, the heating of the structure promotes and completes unfinished reactions. The heating may be at a temperature in a range of 40-100° C. The post-cure heating step also promotes transparency of the product by reducing opacity of the material.

The method 200 as shown in FIG. 2 of forming a styrene-derivative-based product is highly scalable and compatible with additive manufacturing (e.g., light-based 3D printing methods such as direct light processing, projection micro-stereolithography (PμSL), etc.). In various approaches, the product has physical characteristics of formation by an additive manufacturing technique. In various approaches, physical characteristics may include filaments arranged in a geometric pattern, a patterned outer surface defined by stacking filaments, etc. Thus, using these additive manufacturing techniques allows engineering of parts and production of optimal geometry for efficient radiation detection and mechanical strength.

In a preferred approach, the formulation may be exposed to the light during performance of an additive manufacturing technique that uses the formulation as a resin for formation of a three-dimensional structure having a geometric pattern. This formulation may be cured using a light at preferably 365 nm. Application of the light may include shining the light using a separate lamp, an additive manufacturing apparatus incorporating such a lamp, a laser at a similar wavelength, etc. When exposed to a light at a certain wavelength, e.g., 365 nm, at an intensity of 100 mW/cm², the formulation undergoes rapid polymerization within minutes, depending on the thickness of the printed features. In some approaches, a PVT scintillator sample may be prepared using lower levels of light intensity, e.g., a mild UV irradiation at about 20 mW/cm² or less for about 4 hours, depending on the thickness of the printed features, structure, etc. and possibly as low as a range of 1 to 5 mW/cm². In some approaches, a sensitizer (e.g., an accelerant) may be used. Sensitizers are sometimes used to facilitate the formation of radicals with another co-initiating species and can often promote faster polymerization speeds under mild irradiation than formulations without sensitizers. In some approaches, sensitizers may be used to make a resin reactive when exposed to light at another wavelength of interest, such as 385 or 405 nm lamps that are common in some light directed AM apparatuses, e.g., SLA printers.

In some approaches, the photopolymerized PVT scintillator may undergo an additional post-curing step to ensure complete curing and to strengthen the material. For example, the photo polymerized PVT scintillator may be placed in an oven at about 70° C. oven for about 24 hours. In preferred approaches, the additional curing step produces a hard, transparent sample of PVT.

Moreover, this formulation also has higher light output performance than other photocurable scintillators known in the art, increasing the performance of radiation detectors made this way. According to various approaches, a cationically photopolymerized PVT sample generates light output as high as approximately 8400 photons/MeV. The photo polymerization process using a cationic initiator may be tuned for optimal cure lamp intensities, cure environments, post-cure processes, etc.

In one example of an aspect of the invention, an optimal wavelength of light for curing the formulation including vinyl toluene, a primary dye, a secondary dye, and a cationic photoinitiator was determined from spectral data of components of the formulation. FIG. 3 depicts the spectral data of a primary absorbers, e.g., a primary fluorophore PHF and vinyl toluene, a secondary absorber, e.g., secondary fluorophore SFS, and a cationic photoinitiator, e.g., HNu-254, relative to the photon source, according to one approach. The top panel shows the wavelength emission of the photon source, confirming a 254 nm lamp emits at about 254 nm, the 365 nm lamp (e.g., a mild UV source) emits at about 365 nm, and the light from the PhotoDSC (calorimetry apparatus, see below) emits at a broad range of wavelengths, primarily above 300 nm and below 500 nm.

The middle panel depicts primary absorbers such as a glass slide representing the glass vial in which the polymerization of the formulation sometimes takes place, vinyl toluene, and the primary dye PhF. The vinyl toluene (dash line) has highest intensity of absorption in the range of 254 nm, within a similar range of wavelength as the photoinitiator HNu-254, around 250 nm, so vinyl toluene may inhibit the absorption of the photoinitiator at the preferred wavelength. Absorption of PhF (dash-dot line) shows an absorption maximum peak around 280 nm, outside the range of absorption of vinyl toluene. PhF absorbs light that would normally reach the initiator to start the reaction.

The bottom panel depicts the secondary absorbers being the smallest concentration components in the formulation. The photoinitiator HNu-254 (solid line) has an absorbance maximum centered around 254 nm. The goal is for the light emission as depicted in the top panel to reach the HNu-254 photoinitiator depicted in the bottom panel. However, in various attempts, no reaction was observed during irradiation at 254 nm. Vinyl toluene absorbs strongly at this same wavelength and both PhF and the glass walls of the vial contribute some absorption of light thereby dramatically inhibiting initiation.

The lamp centered at 365 nm and the broad PhotoDSC light source both supply wavelengths red-shifted far enough from vinyl toluene to initiate cationic polymerization, in the 300-350 nm range. This range of wavelengths also overlaps with the maximum absorbance of the fluorophore PhF, the absorbance of secondary fluorophore SFS (dotted line, bottom panel), and also the fluorescent emission of PhF, any of which may impact photoinitiation via HNu-254.

Furthermore, it is surprising that the cationic initiator in the formulation initiates rapid polymerization of the vinyl toluene in response to a light at a wavelength that may not be a perfect match with the wavelength designated for the cationic initiator. In contemplated approaches, cationic polymerization of the formulation is not successful using a light source with a wavelength of 254 nm (the preferred absorbance of the cationic initiator HNu-254, as shown in the bottom panel of FIG. 3). Despite the optimized absorbance at 254 nm for HNu-254, vinyl toluene absorbs strongly below 300 nm and effectively inhibits polymerization. Because the total amount of HNu-254 is typically a few orders of magnitude less than the amount of vinyl toluene, and without wishing to be bound by any theory, it is believed that any incoming light below 300 nm is more likely to be absorbed by vinyl toluene than absorbed by HNu-254 to initiate a photopolymerization reaction. However, it was encouraging and surprising that the cationic initiator HNu-254 absorbs just enough light from 365 nm centered sources to drive the cationic polymerization reaction. In other words, the cationic initiator having a peak absorbance of 254 nm as recommended by the manufacturer can also work efficiently with a light at 365 nm. Without wishing to be bound by any theory, certain cationic initiators, e.g., HNu-254, may work exceptionally well in the disclosed resin during exposure to light in a broad range of wavelengths because the small amount of HNu-254 that is absorbed above 300 nm is sufficient to drive the polymerization of the formulation of vinyl toluene monomers, the fluorophores, etc. to completion.

In one example, some 365 nm sources may have a narrower set of emission wavelengths that are not able to polymerize our resins, even with large exposures. Without wishing to be bound by any theory, it is believed that the tail of the 365 nm down towards the blue end of the spectrum that is responsible for initiation. This type of response is a function of how the wavelengths of the light source align with photo blockers, sensitizers, and photoiniators in the resin formulations.

In some approaches, a cationic photoinitiator that absorbs around 365 nm may be a preferable initiator for the cationic polymerization of vinyl toluene and hydrocarbon fluorophore dopants.

Photo differential scanning calorimetry (PhotoDSC) may be used to measure photo-polymerization kinetics of a composition. Thus, the kinetics of the scintillator cure process may be examined using PhotoDSC. Photocalorimetry is a technique by which the heat produced during a photoinitiated reaction may be measured in real time. The heat flow may be used to compare how fast a reaction initiates when exposed to light, the speed of a reaction, and the total conversion of polymerizable groups. In this regard, PhotoDSC is a very useful and sensitive technique for investigating exposure time, light intensity, and heat flows relevant to additive manufacturing processes. Other suitable processes that can evaluate kinetics of photopolymerization include real-time Fourier Transform infrared spectroscopy (RT-FTIR) and UV rheology.

Baseline determination is necessary to account for the difference in heat capacity between the sample and reference pan used in the DSC instrument. Relative to the reference pan, the larger heat capacity and absorbance of the loaded sample pan produces a flat baseline of heat when the photon source is turned on and must be accounted for when calculating heat produced by chemical reaction. For purposes of this disclosure, the calculation of total monomer conversion (using PhotoDSC data) may include values for the styrene as an approximation of the styrene derivative vinyl toluene:

$$\% Conversion = 100 \times \frac{{\int }_{0}^{t} q ( t ) dt}{Δ {H}_{p o l y} \times {n}_{vinyl}} \qquad Equation 1$$

ΔH_{poly} is the theoretical heat of polymerization of styrene and may approximate how much heat is produced when one of the double bonds of VT is polymerized, and n_{vinyl} is the number of moles of vinyl toluene (VT) in the reaction to be cured, this value is based on the weight of the sample. The denominator of Equation 1 determines how much heat could potentially be created by chemical reactions in the sample formulation. The integral of q(t) is a heat measurement representing the total heat measured over the time duration of the complete reaction. This fraction of heat provides an estimation of the percentage of groups reacted in the sample formulation.

According to various approaches, the primary dopant, e.g., primary dye, has a significant effect on the rate of curing a PVT scintillator material by cationic polymerization.

In preferred approaches, vinyl toluene (VT) monomers may be cationically photopolymerized to completion using an iodonium salt photoinitiator to fabricate scintillator material. Conversion of the monomers may be defined as the number of reactive functional groups that participate in polymerization, often expressed as a percentage as calculated in Equation 1. In one example, the cationic polymerization mechanism results in higher conversion in less than 30 seconds using less than 0.5 wt. % of initiator. Further, an addition of a primary fluorophore, e.g., PhF, at low concentration may slow reaction kinetics, but reaction kinetics using higher concentrations of PhF, e.g., 20 wt. %, remain above the reaction kinetics of undoped vinyl toluene solutions. When implementing the photocationic process to cure solids in a mold, a side effect of fast cure rates is stress and cracking of the containers holding bulk samples during polymerization. Preferred molds may include using Teflon molds, instead of glass, to mitigate the stress, cracking, etc. of the molds. In some approaches, silicone molds react unfavorably with the cationic polymerization, leading to cloudy solids.

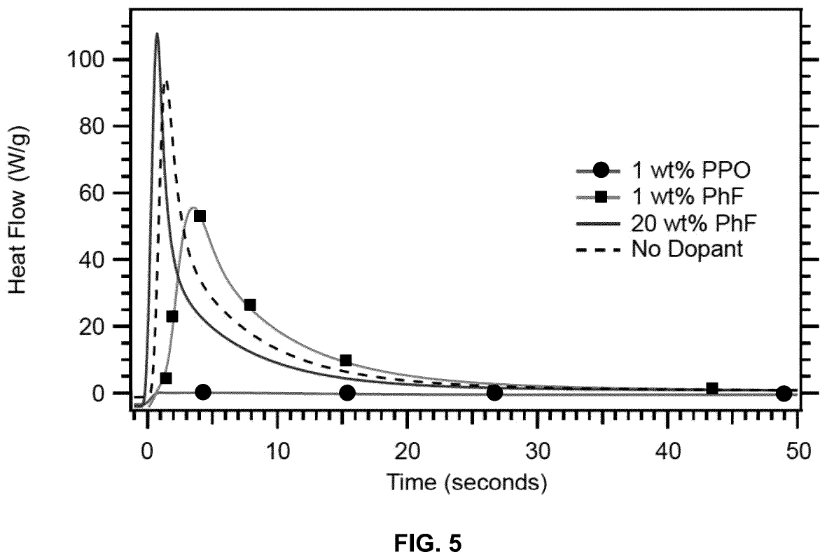

In various approaches, polymerization of the formulation during exposure to light occurs quickly. With the maximum absorbance of PhF covering a significant portion of HNu-254's absorbance (as illustrated in FIG. 3) one would expect that PhF would slow or even inhibit the initiation of cationic polymerization. At low concentrations (1 wt % PhF), the reaction was slowed. However, inventors were surprised that in exemplary formulations (illustrated in FIG. 5, Experiments Section) despite the presence of higher loadings of PhF (up to 20 wt %), the cationic initiator performs quickly and efficiently, such that the polymerization proceeds to completion in the vinyl toluene samples doped with PhF.

This increase in cure kinetics with increasing primary dopant loading is advantageous for scintillator fabrication, where higher concentrations of dopant may be utilized for advanced spectroscopy techniques such as pulse shape discrimination (PSD). The unexpected trend of increasing cure kinetics may be due to an energy transfer process between excited PhF molecules and the HNu-254 initiator made possible by the spectral overlap of their fluorescence and absorbance (see FIG. 3). Alternatively, the increasing cure kinetics may be due to changes in gelation time with increasing solute. Without wishing to be bound by any theory, an increase in primary dopant loading may increase cure kinetics of styrene-based resins in general, e.g., not limited to scintillator material. In one aspect, an amount of primary dopant in a styrene-based resin may be tuned to increase kinetics of cationic polymerization of the styrene-based resin.

The curing kinetics of the cationic polymerization of a PVT system may not only be impacted by the wavelength of light and chemical composition, but also by the intensity or dose of light. In a 3D printing application, the intensity or dose of light can often be tuned.

In some approaches, a wide range of intensities (e.g., 20 to 150 mW/cm²) initiate high conversion rates, e.g., greater than 90% conversion. Low intensity light sources such as hand-held lamps may efficiently cure vinyl toluene solutions through the photoinitiated mechanism as described herein. In some contemplated approaches using PhotoDSC, photoinitiator concentrations may be adjusted to tune the reaction kinetics without causing a significant loss of overall curing. Moreover, these approaches may be tuned for 3D printing and applications outside of additive manufacturing, such as casting, gluing, coating, etc.

According to one inventive aspect, a formulation results in photocurable polyvinyl toluene (PVT) with properties suitable for additive manufacturing (AM). In preferred approaches, the formulation may be tuned for AM of mixed material scintillator system, such as an architected multimaterial scintillator system (AMSS) for an advanced radiation detector concept.

In one inventive aspect, a formulation may be suitable for production of scintillators formed by additive manufacturing involving photopolymerization. According to various approaches, producing PVT using a manufacturing process as described herein is an advantageous way to produce various types of radiation detectors having advanced detection capabilities that utilize precisely manufactured multimaterial architecture. In preferred approaches, the rapid light-induced polymerization of the resin allows printing of structures having precise, fine features, e.g., filaments, ligaments, etc.

In some approaches, the rapid curing of cationic polymerization allows a print image of a building part to be changed between layers, allowing for non-monolithic print geometry. For example, a part may be built in a bath of uncured resin. For each layer, the light is specifically focused on a 2D projection plane where the resin exposed to UV light is cured. The part then is moved away from the projection plane, recoated with resin, brought back to the image plane within the bath, and cured. This process allows the next layer to be cured on the same plane, thus enabling the print image to be changed between layers. This process thereby forms a product having a non-monolithic geometry.

In various approaches, PVT scintillator products may be fabricated using 3D printers using UV light to cure resins in a layer-by-layer fashion. In one approach, a 3D printer may be a stereolithography (SLA) type printer that uses a rastered UV laser. In another approach, the 3D printer may be a digital light processing (DLP) type printer that uses a projected mask with a UV light.

In preferred approaches, the formulation as described herein has cure behavior more similar to conventional AM resins used for non-scintillator products. The formulation enables faster reaction kinetics resulting in faster prints, finer control over the printed structure, enabling printing of larger pieces, etc. These significant advantages in printing allow this formulation to be used as a feedstock for producing radiation detectors that require precisely structured scintillators, including the architected multimaterial scintillator system concept as well as other conceptual detectors previously identified in the radiation detection field, including arrays of optically separated segments or cubes.

According to one inventive aspect, a preferred formulation may be used for fabrication of a PVT scintillator via cationic photoinitiation. The approaches described herein identifies the application of a preferred formulation for additive manufacturing (AM) generally. Moreover, the AM formed PVT via cationic photoinitiation may be a preferred approach some varieties of the AMSS detector concept. For example, AM techniques using the formulation and process described herein may be applied for fabricating pixelated scintillator arrays thereby eliminating the need for the multiple fabrication steps necessary in conventional fabrication routes (e.g., casting, machining, polishing, etc.). The formulations described herein may be used to form scintillator structures as disclosed in U.S. patent application Ser. No. 17/232,521, which is herein incorporated by reference.

According to one inventive aspect, a product includes a printed 3D structure comprising a scintillator material where the scintillator material includes a styrene-derivative-based polymer matrix, a primary dye, and a secondary dye. In one approach, the printed 3D structure may be a monolithic structure. In a preferred approach, the printed 3D structure may have non-monolithic geometry. In an exemplary approach, the printed 3D structure has a plurality of layers arranged in a geometric pattern. In one approach, the 3D structure may be a pixelated scintillator array.

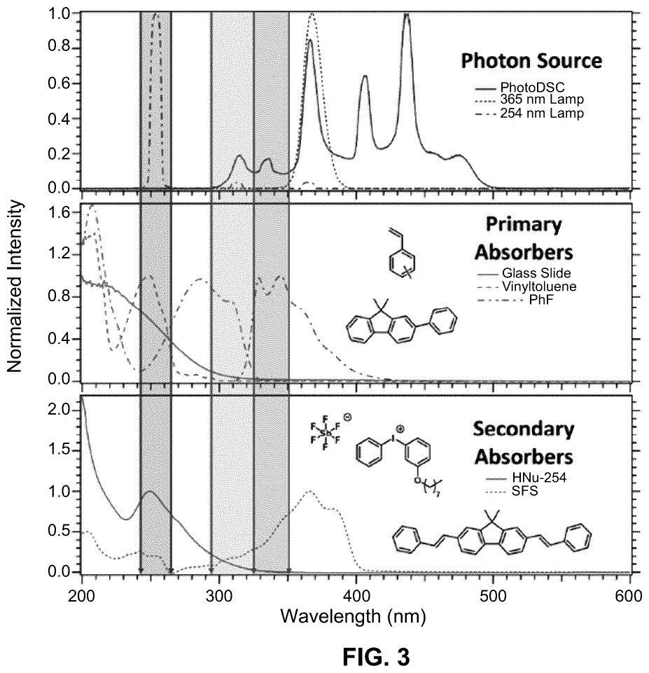

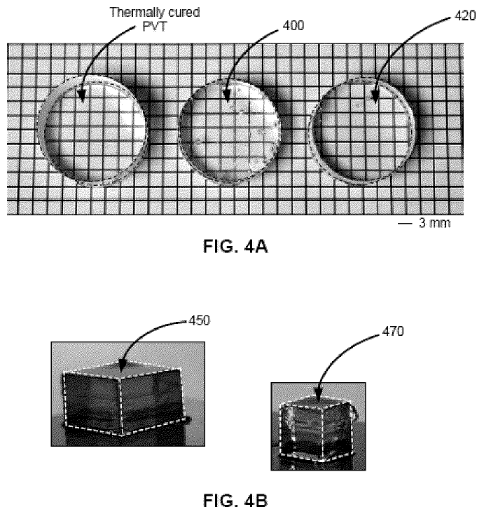

Various approaches of the inventive concept are depicted in the images of FIGS. 4A-4B that illustrate examples of scintillator products 400, 420, 450, 470. As an option, the present products 400, 420, 450, 470 may be implemented in conjunction with features from any other inventive aspect listed herein, such as those described with reference to the other FIGS. Of course, however, such products 400, 420, 450, 470 and others presented herein may be used in various applications and/or in permutations which may or may not be specifically described in the illustrative inventive aspects listed herein. Further, the products 400, 420, 450, 470 presented herein may be used in any desired environment.

FIG. 4A is an image of bulk samples of PVT scintillator products 400, 420 formed using cationic polymerization process as described herein. The two PVT scintillator products have different amounts of cationic initiator, HNu-254. In one example, PVT scintillator product 400 includes 1 wt. % PhF primary dye, 0.1 wt. % SFS secondary dye, and 0.04 wt. % HNu-254. In another example, PVT scintillator product 420 includes 1 wt. % PhF primary dye, 0.1 wt. % SFS secondary dye, and 0.02 wt. % HNu-254. The bulk sample on the far left is a PVT scintillator product formed by conventional free-radical methods involving thermal curing. The PVT scintillator products 400, 420 are optically transparent. Each sample has an approximate diameter of 1 inch, approximately 25.4 mm.

PVT scintillator products formed by cationic polymerization demonstrate scintillation in response to ionizing radiation. In preferred approaches, the scintillator material is configured for pulse shape discrimination. For example, PVT scintillator material is configured to, upon exposure to radiation, emit light amenable to pulse-shape discrimination of the type of radiation. When certain types of radiation interact with a scintillator solid, optical pulses of scintillation light yield are produced with a distinct decay time that correspond with the type of incident radiation. A clear difference in decay times from different incident radiations can result in a PSD capable scintillator. PVT scintillators may achieve PSD, and thus these scintillators may demonstrate a gamma-neutron separation (i.e., Figure of Merit (FoM)>1) when loaded with the appropriate concentration of dyes.

In one exemplary approach, printed 3D structures comprising a PVT scintillator material are illustrated in the image of FIG. 4B. In one example, products 450, 470 depicted in FIG. 4B are 3D printed structures of PVT scintillator material formed using cationic polymerization during 3D printing of the structures. The scintillator material of each product 450, 470 includes a vinyl toluene polymer matrix with divinylbenzene. Each product was formed from a resin comprising 50:50 PVT:divinyl benzene and printed using a DLP printer. Each product 450, 470 is a 3D printed structure having a plurality of layers arranged in a geometric pattern. However, the formulation for this approach produces a yellow/brown color under the printing conditions.

Experiments

Vinyl toluene monomer m- and p-formulation, TBC inhibited, (98+%) was purchased from TCI America and used after removal of inhibitor via a basic alumina column. All other purchased chemicals were used as received. H-Nu 254 photoinitiator was purchased from Spectra Photopolymers (Millbury, OH), consisting of 99% (4-(Octyloxy)phenyl)(phenyl)iodonium hexafluorostibate (V). 2,5-diphenyloxazole (99%) was purchased from Sigma Aldrich. 1″ diameter cylindrical Teflon molds were purchased from Sturbridge Metallurgical Services, Inc.

9,9-dimethyl-2-phenylfluorene (PhF) and 9,9-dimethyl-2,7-distyrylfluorene (SFS) were synthesized and purified using the procedures outlined in previous publications.

All calorimetry was performed using a TA Instruments Q2000 differential scanning calorimeter which was equipped with an Omnicure S2000 photon source for photocalorimetry. For chemical characterization, a 500 MHz Jeol ECA-500 NMR and Agilent 7890B GC with 5977B MSD were used. UV-vis absorbance and optical fluorescence were measured on a Beckman Coulter DU 800 spectrometer and Horiba Jobin Yvon NanoLog Model FL-1057 fluorimeter.

Vials were silanized using a dichloromethane solution consisting of 10 vol % dichlorodimethylsilane. This solution was vigorously stirred and let sit in vials for 30-60 minutes to coat the walls of the vials. The solution was then discarded, and the vials were gently rinsed with dichloromethane followed by methanol. Vials were let dry completely before use. Teflon molds were used as received without any further treatment.

A phenol-based inhibitor, e.g., methoxyphenol, inhibitor was removed from vinyl toluene using a basic alumina column. A 1 inch diameter column packed with 6 inches of alumina followed by 1 inch of potassium carbonate was sufficient for removal of inhibitor from over 100 g of vinyl toluene. The final product was dried over magnesium sulfate, filtered, and stored below freezing in the dark under an argon atmosphere.

Samples were comprised of a vinyl toluene solution with between 1 and 20 wt. % 9,9-dimethyl-2-phenylfluorene (PhF), 0.1 wt. % 9,9-dimethyl-2,7-distyrylfluorene (SFS), and 0.01 to 0.04 wt. % HNu-254. HNu-254 is a cationic photo initiator consisting of 99% (4-(Octyloxy)phenyl)(phenyl)iodonium hexafluorostibate (V), while PhF and SFS are fluorophores responsible for luminescence.

All components are soluble in both vinyl toluene solution and final polyvinyl toluene plastic to yield clear transparent materials. Only a very small amount of HNu-254 photoinitiator was necessary to initiate polymerization, which proceeds exothermically until a hard solid plastic is formed. When cured in glass vials sample almost always cracked due to the brittle plastic, large shrinkage during curing, and inflexible glass molds. Teflon molds, however, were sufficiently flexible and non-adherent to the plastic that cracking was avoided. Silicone molds reacted with the vinyl toluene during polymerization whether commercial produced polydimethylsiloxane molds, or custom molds cast using Elastosil 7665 or Sylgard 184 resins.

In samples containing only vinyl toluene and HNu-254 a yellow color developed that partially dissipated with time and mild heating. This recovery of transparency is reminiscent of polystyrene and polyvinyl toluene's ability to recover transparency after ionizing radiation damage. It is possible that the cationic mechanism or UV-exposure causes yellowing in a similar way, or that iodo-byproducts of the initiation steps cause coloration. Samples were exposed to a variety of light sources for attempted curing: a 254 nm lamp, a 365 nm lamp, and a broad 200-500 nm spot curing light source. These light sources, as well as the absorbance and emission of the different components used in the scintillating solutions, are shown in FIG. 3.

PhotoDSC samples (1 uL) were prepared in TZero aluminum pans covered by a glass window to prevent sample evaporation. Duplicate samples were measured a total of 5 times. Photocurable scintillator solutions were prepared by dissolving fluorophores of desired concentrations in inhibitor-stripped vinyl toluene. A heat flow baseline was extrapolated from the final isothermal region of the PhotoDSC exotherm that indicates reaction completion.

All solutions for measurement via photocalorimetry were prepared in foil-wrapped 2 dram vials. Solutions were mixed thoroughly and stored in the dark. DSC pan weights were measured to the tenth of a milligram, and 1 uL of sample solution was measured using a microsyringe with 0.1 uL graduations. Both sample and reference pans were covered with a glass square to prevent sample evaporation.

Five replicate samples were prepared and measured for each composition of interest. The photoinitiated exotherm peak area and peak height were measured by extrapolating a horizontal baseline back from the first isothermal heat flow. Peak area is defined as the signal above the extrapolated horizontal baseline, and peak height is the difference between baseline and signal maximum. Outliers defined as being greater than 1.5 times the interquartile range were removed.

Bulk samples were cured between two 4 Watt UV lamps whose spectrum is centered at 365 nm, shown in FIG. 3. Initiator, dopant, and vinyl toluene were mixed thoroughly and cured in either a vial with silanized surfaces sealed under a layer of argon, or an open Teflon mold sealed in a nitrogen atmosphere glovebox. An inert atmosphere layer is not necessary for polymerization but prevents detrimental effects to scintillation from oxygen exposure.

The solutions were then cured under irradiation for 3 hours at room temperature, followed by a room temperature post-cure period of at least 12 hours. The silanized glass vial was broken and the scintillator samples were retrieved for further characterization, or samples were pushed out of Teflon molds.

Exotherm Curves for Different Dopants

FIG. 5 depicts the curing exotherm curves for different dopants and dopant concentrations in the absence of secondary dopant. The curves depicted in FIG. 5 demonstrate how fast the polymerization reactions are happening with each formulation. Note, the undoped vinyl toluene (dashed line) depicted fast and efficient polymerization with HNu-254. The vinyl toluene doped with PPO predictably did not demonstrate any cationic polymerization with the initiator HNu-254.

It is apparent that 1 wt. % PhF loading causes the curing reaction to reach lower heat flow at a later point in time, indicating slower initiation and propagation in comparison to solutions with no dopant. Surprisingly, when PhF content is increased in concentration up to 20 wt. % the curing exotherm peaks much faster and at much higher heat flows.

During photoinitiated cationic polymerization, PPO completely inhibits curing as shown by the lack of an exotherm for 1 wt. % loaded PPO in FIG. 5. It is a known occurrence for proton traps to suppress cationic polymerization. Traditional primary and secondary dopants such as PPO and 1,4-bis(5-phenyl-2-oxazolyl)benzene (POPOP) are not compatible with cationic polymerization mechanisms.

Effect of the Light Intensity During Curing

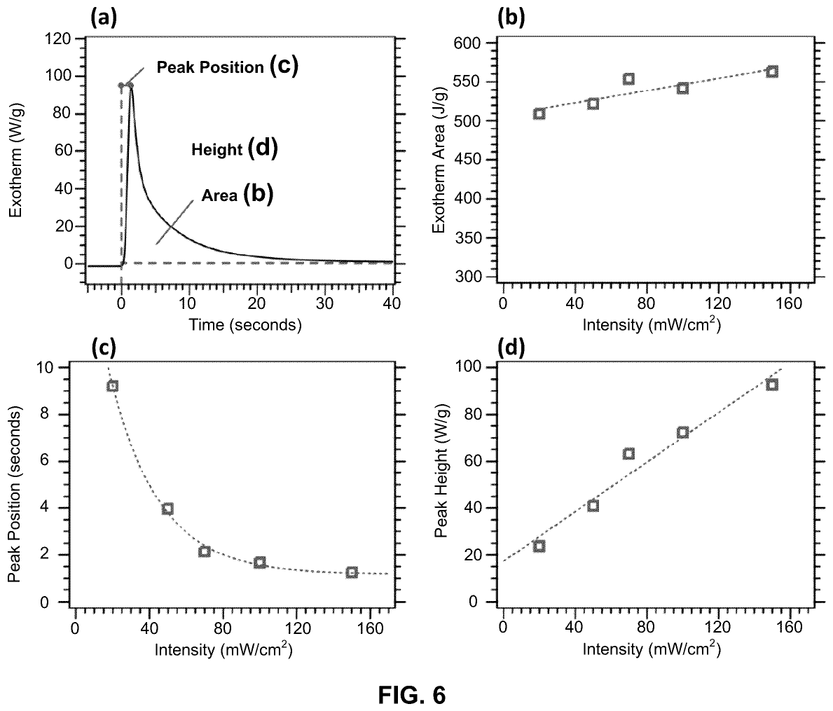

As depicted in FIG. 6, using undoped vinyl toluene with 0.04 wt. % HNu-254, key parts of the exotherm curve as shown in part (a) were examined for the impact of increasing light intensity. With increasing light intensity, the peak height (part (d)) is linearly correlated with light intensity, the peak area (part (b)) demonstrates a relatively smaller increase in area with increasing light intensity, and the peak position (part (c)) as measured in time (seconds) approaches a lower limit with increased light intensity. Without wishing to be bound by any theory, these patterns imply that higher light intensity causes reactions to initiate sooner and propagate faster.

In Use

Various inventive aspects described herein may be used for radiation detection (including gamma and neutron detection), in particular: fast neutron detection, directional neutron detection, neutron/gamma discrimination, precise position resolution (and the specific applications that require position resolution, such as scatter cameras and radiation imaging). Moreover, inventive aspects described herein may be used for Mixed Material Scintillation System (MMSS), Architected Multimaterial Scintillator Systems (AMSS), etc.

The inventive aspects disclosed herein have been presented by way of example to illustrate the myriad features thereof in a plurality of illustrative scenarios, aspects of an inventive aspect, and/or implementations. It should be appreciated that the aspects generally disclosed are to be considered as modular, and may be implemented in any combination, permutation, or synthesis thereof. In addition, any modification, alteration, or equivalent of the presently disclosed features, functions, and aspects that would be appreciated by a person having ordinary skill in the art upon reading the instant descriptions should also be considered within the scope of this disclosure.

While various aspects of an inventive aspect have been described above, it should be understood that they have been presented by way of example only, and not limitation. Thus, the breadth and scope of an aspect of an inventive aspect of the present invention should not be limited by any of the above-described exemplary aspects of an inventive aspect but should be defined only in accordance with the following claims and their equivalents.

What is claimed is:

1. A formulation for forming a styrene-based scintillator using light-directed additive manufacturing techniques, the formulation comprising:
a base monomer comprising one or more styrene-derivative monomers;
a primary dye;
a secondary dye; and
a cationic photoinitiator.

2. The formulation as recited in claim 1, wherein the one or more styrene-derivative monomers comprise at least one type of monomer selected from the group consisting of: a vinyl toluene monomer, a styrene monomer, a divinyl benzene monomer, and a methyl-substituted derivative.

3. The formulation as recited in claim 1, wherein the one or more styrene-derivative monomers is a multifunctional monomer having at least two functional sites for crosslinking.

4. The formulation as recited in claim 1, wherein the cationic photoinitiator includes an iodonium salt.

5. The formulation as recited in claim 1, wherein the cationic photoinitiator includes an iodonium hexafluorostibate salt.

6. The formulation as recited in claim 1, wherein the one or more styrene-derivative monomers effectively acts as a solvent for dissolution of the primary and secondary dyes of the formulation.

7. The formulation as recited in claim 5, wherein the formulation does not include an additional solvent.

8. The formulation as recited in claim 1, wherein the formulation is essentially free of a protic solvent.

9. The formulation as recited in claim 1, wherein the formulation does not include any other monomer than the base monomer, the base monomer being the one or more styrene-derivative monomers.

10. The formulation as recited in claim 1, further comprising an acrylate monomer.

11. The formulation as recited in claim 1, wherein the formulation is essentially free of particles.

12. The formulation as recited in claim 1, further comprising small molecules that are soluble in the one or more styrene-derivative monomers.

13. The formulation as recited in claim 1, wherein the primary dye is a first aromatic hydrocarbon fluorophore and/or the secondary dye is a second aromatic hydrocarbon fluorophore.

14. The formulation as recited in claim 1, wherein the primary dye and the secondary dye do not include nitrogen.

15. A product, comprising:
a printed three-dimensional structure comprising a scintillator material, the scintillator material comprising:
a styrene-derivative-based polymer matrix,
a primary dye, and
a secondary dye,
wherein the printed three-dimensional structure has a plurality of layers arranged in a geometric pattern.

16. The product as recited in claim 15, wherein the three-dimensional structure has a non-monolithic geometry.

17. The product as recited in claim 15, wherein the three-dimensional structure is a pixelated scintillator array.

18. The product as recited in claim 15, wherein the scintillator material is configured for pulse-shape discrimination.

19. A method for forming a scintillator product, the method comprising:
obtaining a formulation comprising a base monomer comprising one or more styrene-derivative monomers, a primary dye, a secondary dye, and a cationic photoinitiator;
exposing the formulation to light for polymerizing the formulation to form a structure comprising a styrene-derivative-based polymer matrix; and
heating the structure to cure the polymer matrix to at least a predefined extent.

20. The method as recited in claim 19, wherein the formulation is exposed to the light during performance of an additive manufacturing technique that uses the formulation as a resin for formation of a three-dimensional structure having a geometric pattern.
